(19) United States
(12) Patent Application Publication
(10) Pub. No.: US 2009/0123673 A1
(43) Pub. Date: May 14, 2009

(54) HEAT-SENSITIVE TRANSFER SHEET AND HEAT-SENSITIVE TRANSFER RECORDING METHOD

(75) Inventors: Naotsugu MURO, Minami-ashigara-shi (JP); Yoshihiko FUJIE, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/269,134

(22) Filed: Nov. 12, 2008

(30) Foreign Application Priority Data
Nov. 12, 2007 (JP) 2007-293674

(51) Int. Cl. B41M 5/40

(52) U.S. Cl. 428/32.6

(57) ABSTRACT

A heat-sensitive transfer sheet having at least one dye layer formed on one side of a base sheet, wherein the dye layer contains at least one kind of dye represented by formula (1) and at least one kind of dye represented by formula (2),

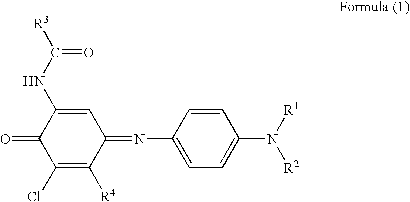

wherein, in formula (1), R¹ and R² each independently represent a substituted or unsubstituted alkyl group having 1 to 8 carbon atoms; R³ represents a substituted or unsubstituted alkyl group having 1 to 8 carbon atoms or a substituted or unsubstituted alkoxy group having 1 to 6 carbon atoms; and R⁴ represents a methyl group or an ethyl group, and

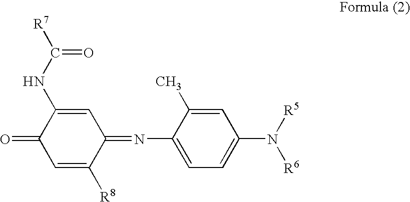

wherein, in formula (2), R⁵ and R⁶ each independently represent a substituted or unsubstituted alkyl group having 1 to 8 carbon atoms; R⁷ represents a substituted or unsubstituted alkyl group having 1 to 8 carbon atoms or a substituted or unsubstituted alkoxy group having 1 to 8 carbon atoms; and R⁸ represents a methyl group or an ethyl group.

### FIELD OF THE INVENTION

The present invention relates to a heat-sensitive transfer sheet and a heat-sensitive transfer recording method.

### BACKGROUND OF THE INVENTION

In recent years, in particular, materials for forming a color image have been mainly used as an image recording material. Specifically, recording materials of inkjet system, recording materials of heat-sensitive transfer system, recording materials of electrophotographic system, silver halide photosensitive materials of transfer system, printing inks, recording pens, and the like, have been used extensively. Color filters are used in image devices, such as image pick up device like CCD (Charge Coupled Device), and in displays, such as LCD (Liquid Crystal Display) and PDP (Plasma Display Panel), to record and reproduce color images.

In these color image recording materials and color filters, colorants (dyes or pigments) of three primary colors are used based on a so-called additive color mixing system or subtractive color mixing system, to reproduce or record full-color images. A colorant having suitable properties for various conditions for use has not been available yet, and its improvement is strongly desired.

As the heat-sensitive transfer recording method, there are a process including the steps of heating a heat-sensitive transfer material having a base material sheet (hereinafter, also referred to as “base sheet”, “support” or “base film”) and a hot-melt ink layer formed thereon with a thermal head, and recording the melted ink to an image-receiving material; and a process including the steps of heating a heat-sensitive transfer sheet (hereinafter, also referred to as “an ink sheet”) having a support and a dye layer (hereinafter, also referred to as “a dye-providing layer”, “a heat-sensitive transfer layer”, “a thermal transfer layer” or “a colorant layer”) formed thereon that contains a heat transfer dye with a thermal head, and thermal-diffusionally transferring the dye onto an image-receiving material. The latter heat-sensitive transfer process is able to change a transfer amount of the dye by altering energy applied to a thermal head, so that a gradation recording is easily achieved. Consequently, such the process is especially advantageous to a high quality full color recording. However, because the heat transfer dye usable in the process is limited in various points, only a considerably few dyes satisfy all the performances required for the process.

Performance requirements for the dyes include bearing spectral characteristics desirable for color reproduction, causing sublimation and/or transfer by a thermal recording head, having a high molecular extinction coefficient, being fast to light and heat, resisting attack by various chemicals, having easiness of synthesis, ensuring easy production of heat-sensitive transfer recording materials, and being safe. In addition to the above performances in which the improvement has been long desired, there have been arisen a new problem in recent years. Specifically, imaging defects associated with increase in printer printing speed, such as defects in separation of ink sheet from heat-sensitive transfer image-receiving sheet (hereinafter, referred to as “image-receiving sheet”) during high-speed transfer and image defects caused by streaking which are probably generated by the change in frictional force applied both to the ink sheet and the image-receiving sheet, are occurred.

Indoaniline-based cyan dyes were known to be used as dyes for sublimation-type heat-sensitive transfer recording (see, for example, European Patent No. 147747A2 and JP-A-61-35994 (“JP-A” means unexamined published Japanese patent application)). Also known were systems in combination of two particular indoaniline-based cyan dyes (see, for example, JP-B-5-15198 (“JP-B” means examined Japanese patent publication) and JP-A-10-181222), in combination of a particular indoaniline-based cyan dye and a particular cyan dye having a particular wavelength and molecular weight (see, for example, JP-A-2-74683), and in combination of three particular indoaniline-based cyan dyes (see, for example, JP-A-2000-185475).

As described above, the market demand for a sublimation-type printer having higher printing speed continues to increase in recent years. The technologies described in the above documents can provide a printing image which meets to some extent the user's demands of performances such as transfer density, light fastness and aging property of an ink sheet. However, it is still difficult to improve image defects caused by wrinkling of the ink sheet (in particular, image defects caused by oblique streaks (length: 3 mm or more) formed in an inclined direction in the print side regions (edge regions in parallel with the print conveying direction), hereinafter, referred to as a ribbon wrinkle (crease)) during high-speed printing. Therefore, there is desired for an ink sheet satisfying the high-level performances demanded during such high-speed printing.

### SUMMARY OF THE INVENTION

The present invention resides in a heat-sensitive transfer sheet comprising at least one dye layer formed on one side of a base sheet, wherein the dye layer contains at least one kind of dye represented by formula (1) and at least one kind of dye represented by formula (2),

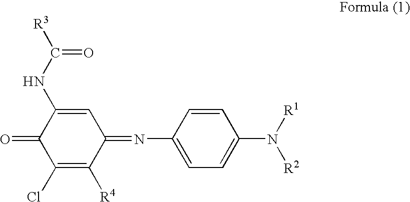

wherein, in formula (1), R¹ and R² each independently represent a substituted or unsubstituted alkyl group having 1 to 8 carbon atoms; R³ represents a substituted or unsubstituted alkyl group having 1 to 8 carbon atoms or a substituted or unsubstituted alkoxy group having 1 to 6 carbon atoms; and R⁴ represents a methyl group or an ethyl group, and

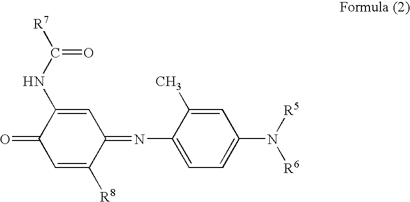

wherein, in formula (2), R⁵ and R⁶ each independently represent a substituted or unsubstituted alkyl group having 1 to 8 carbon atoms; R⁷ represents a substituted or unsubstituted alkyl group having 1 to 8 carbon atoms or a substituted or unsubstituted alkoxy group having 1 to 8 carbon atoms; and R⁸ represents a methyl group or an ethyl group.

Further, the present invention resides in a heat-sensitive transfer recording method comprising forming an image on a heat-sensitive transfer image-receiving sheet which has an ink receiving layer containing a polymer on a support, by using the heat-sensitive transfer sheet.

Other and further features and advantages of the invention will appear more fully from the following description.

### DETAILED DESCRIPTION OF THE INVENTION

According to the present invention, there is provided the following means:
(1) A heat-sensitive transfer sheet comprising at least one dye layer formed on one side of a base sheet, wherein the dye layer contains at least one kind of dye represented by formula (1) and at least one kind of dye represented by formula (2),

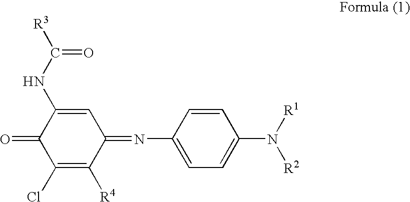

wherein, in formula (1), R¹ and R² each independently represent a substituted or unsubstituted alkyl group having 1 to 8 carbon atoms; R³ represents a substituted or unsubstituted alkyl group having 1 to 8 carbon atoms or a substituted or unsubstituted alkoxy group having 1 to 6 carbon atoms; and R⁴ represents a methyl group or an ethyl group, and

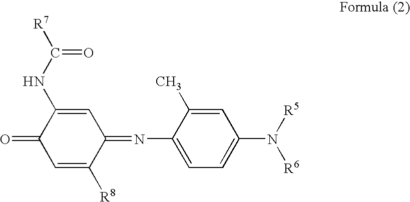

wherein, in formula (2), R⁵ and R⁶ each independently represent a substituted or unsubstituted alkyl group having 1 to 8 carbon atoms; R⁷ represents a substituted or unsubstituted alkyl group having 1 to 8 carbon atoms or a substituted or unsubstituted alkoxy group having 1 to 8 carbon atoms; and R⁸ represents a methyl group or an ethyl group.
(2) The heat-sensitive transfer sheet as described in the above item (1), wherein, in the dye represented by formula (2), R⁵ and R⁶ each independently represent a methyl group or an ethyl group; R⁷ represents a methyl group, an ethyl group or a methoxy group; and R⁸ represents a methyl group.
(3) A heat-sensitive transfer recording method comprising forming an image on a heat-sensitive transfer image-receiving sheet which has an ink receiving layer containing a polymer on a support, by using the heat-sensitive transfer sheet as described in the above item (1) or (2).

(4) The heat-sensitive transfer recording method as described in the above item (3), wherein the image is formed with the line speed of from 0.50 msec/line to 0.73 msec/line.

The heat-sensitive transfer sheet of the present invention and the heat-sensitive transfer recording method of the present invention are described below in detail. The constitutional requirements described below may be embodied on the basis of the representative embodiments of the present invention. However, the present invention is not limited to such embodiments.

In the present specification, “to” denotes a range including numerical values described before and after it as a minimum value and a maximum value.

First, the dye for use in the present invention will be described in detail.

In the present invention, at least one kind of indoaniline-based dye represented by formula (1) and at least one kind of indoaniline-based dye represented by formula (2) are used in combination for the dye layer of the heat-sensitive transfer sheet.

### [Indoaniline Dye Represented by Formula (1)]

Hereinafter, the indoaniline dye represented by formula (1) for use in the present invention will be described in detail.

In formula (1), R¹ and R² each independently represent a substituted or unsubstituted alkyl group having 1 to 8 carbon atoms; R³ represents a substituted or unsubstituted alkyl group having 1 to 8 carbon atoms or a substituted or unsubstituted alkoxy group having 1 to 6 carbon atoms; and R⁴ represents a methyl group or an ethyl group.

Hereinafter, the substituent groups described above and substituent groups that may be substituted additionally thereto will be described in detail.

The halogen atom includes a fluorine atom, a chlorine atom, a bromine atom, and an iodine atom. Of these, a chlorine atom and a bromine atom are preferable, a chlorine atom is particularly preferable.

The alkyl group includes a cycloalkyl group and a bicycloalkyl group. The alkyl group includes a substituted or unsubstituted, linear or branched alkyl group. The substituted or unsubstituted, linear or branched alkyl group is preferably an alkyl group having 1 to 30 carbon atoms. Examples of the alkyl group include a methyl group, an ethyl group, an n-propyl group, an isopropyl group, a t-butyl group, an n-octyl group, an eicosyl group, a 2-chloroethyl group, a 2-cyanoethyl group, or a 2-ethylhexyl group. The cycloalkyl group includes a substituted or unsubstituted cycloalkyl group. The substituted or unsubstituted cycloalkyl group is preferably a cycloalkyl group having 3 to 30 carbon atoms. Examples of the cycloalkyl group include a cyclohexyl group, a cyclopentyl group and a 4-n-dodecylcyclohexyl group. The bicycloalkyl group includes a substituted or unsubstituted bicycloalkyl group having 5 to 30 carbon atoms, i.e. a monovalent group obtained by removing one hydrogen atom from a bicycloalkane having 5 to 30 carbon atoms. Examples of the bicycloalkyl group include a bicyclo[1,2,2]heptan-2-yl group or a bicyclo[2,2,2]octan-3-yl group, and a tricyclo or higher structure having three or more ring structures. An “alkyl” group in a substituent described below (e.g. an “alkyl” group in an alkylthio group) represents such an “alkyl” group of the above concept.

The alkenyl group includes a cycloalkenyl group and a bicycloalkenyl group. The alkenyl group represents a substituted or unsubstituted, linear, branched, or cyclic alkenyl group. The alkenyl group is preferably a substituted or unsubstituted alkenyl group having 2 to 30 carbon atoms. Examples of the alkenyl group include a vinyl group, an allyl group, a prenyl group, a geranyl group, or an oleyl group. The cycloalkenyl group is preferably a substituted or unsubstituted cycloalkenyl group having 3 to 30 carbon atoms, i.e. a monovalent group obtained by removing one hydrogen atom from a cycloalkene having 3 to 30 carbon atoms. Examples of the cycloalkenyl group include a 2-cyclopenten-1-yl group or a 2-cyclohexen-1-yl group. The bicycloalkenyl group includes a substituted or unsubstituted bicycloalkenyl group, and preferably a substituted or unsubstituted bicycloalkenyl group having 5 to 30 carbon atoms, i.e. a monovalent group obtained by removing one hydrogen atom from a bicycloalkene having one double bond. Examples of the bicycloalkenyl group include a bicyclo[2,2,1]hept-2-en-1-yl group or a bicyclo[2,2,2]oct-2-en-4-yl group.

The alkynyl group is preferably a substituted or unsubstituted alkynyl group having 2 to 30 carbon atoms, e.g. an ethynyl group, or a propargyl group.

The aryl group is preferably a substituted or unsubstituted aryl group having 6 to 30 carbon atoms, e.g. a phenyl group, a p-tolyl group, a naphthyl group, an m-chlorophenyl group, or an o-hexadecanoylaminophenyl group.

The heterocyclic group is a monovalent group obtained by removing one hydrogen atom from a substituted or unsubstituted, aromatic or nonaromatic heterocyclic compound, which may be condensed to another ring. The heterocyclic group is preferably a 5- or 6-membered heterocyclic group. The hetero atom(s) constituting the heterocyclic group is preferably a nitrogen atom, a sulfur atom, or an oxygen atom. The heterocyclic group is more preferably a 5- or 6-membered aromatic heterocyclic group having 3 to 30 carbon atoms. The hetero ring in the heterocyclic group are exemplified below without denotation of their substitution sites: a pyridine ring, a pyrazine ring, a pyridazine ring, a pyrimidine ring, a triazine ring, a quinoline ring, an isoquinoline ring, a quinazoline ring, a cinnoline ring, a phthalazine ring, a quinoxaline ring, a pyrrole ring, an indole ring, a furan ring, a benzofuran ring, a thiophene ring, a benzothiophene ring, a pyrazole ring, an imidazole ring, a benzimidazole ring, a triazole ring, an oxazole ring, a benzoxazole ring, a thiazole ring, a benzothiazole ring, an isothiazole ring, a benzisothiazole ring, a thiadiazole ring, an isoxazole ring, a benzisoxazole ring, a pyrrolidine ring, a piperidine ring, a piperazine ring, an imidazolidine ring and a thiazoline ring.

The alkoxy group includes a substituted or unsubstituted alkoxy group. The substituted or unsubstituted alkoxy group is preferably an alkoxy group having 1 to 30 carbon atoms, e.g. a methoxy group, an ethoxy group, an isopropoxy group, an n-octyloxy group, a methoxyethoxy group, a hydroxyethoxy group, or a 3-carboxypropoxy group.

The aryloxy group is preferably a substituted or unsubstituted aryloxy group having 6 to 30 carbon atoms, e.g. a phenoxy group, a 2-methylphenoxy group, a 4-t-butylphenoxy group, a 3-nitrophenoxy group, or a 2-tetradecanoylaminophenoxy group.

The acyloxy group is preferably a formyloxy group, a substituted or unsubstituted alkylcarbonyloxy group having 2 to 30 carbon atoms, or a substituted or unsubstituted arylcarbonyloxy group having 7 to 30 carbon atoms, e.g. a formyloxy group, an acetyloxy group, a pivaloyloxy group, a stearoyloxy group, a benzoyloxy group, or a p-methoxyphenylcarbonyloxy group.

The carbamoyloxy group is preferably a substituted or unsubstituted carbamoyloxy group having 1 to 30 carbon atoms, e.g. an N,N-dimethylcarbamoyloxy group, an N,N-diethylcarbamoyloxy group, a morpholinocarbonyloxy group, an N,N-di-n-octylaminocarbonyloxy group, or an N-n-octylcarbarnoyloxy group.

The alkoxycarbonyloxy group is preferably a substituted or unsubstituted alkoxycarbonyloxy group having 2 to 30 carbon atoms, e.g. a methoxycarbonyloxy group, an ethoxycarbonyloxy group, a t-butoxycarbonyloxy group, or an n-octylcarbonyloxy group.

The aryloxycarbonyloxy group is preferably a substituted or unsubstituted aryloxycarbonyloxy group having 7 to 30 carbon atoms, e.g. a phenoxycarbonyloxy group, a p-methoxyphenoxycarbonyloxy group, or a p-n-hexadecyloxyphenoxycarbonyloxy group.

The amino group includes an alkylamino group, an arylamino group, and a heterocyclic amino group. The amino group is preferably a substituted or unsubstituted alkylamino group having 1 to 30 carbon atoms, or a substituted or unsubstituted arylamino group having 6 to 30 carbon atoms, e.g. an amino group, a methylamino group, a dimethylamino group, an anilino group, an N-methyl-anilino group, a diphenylamino group, a hydroxyethylamino group, a carboxyethylamino group, a sulfoethylamino group, a 3,5-dicarboxyanilino group, or a 4-quinolylamino group.

The acylamino group is preferably a formylamino group, a substituted or unsubstituted alkylcarbonylamino group having 1 to 30 carbon atoms, or a substituted or unsubstituted arylcarbonylamino group having 7 to 30 carbon atoms, e.g. a formylamino group, an acetylamino group, a pivaloylamino group, a lauroylamino group, a benzoylamino group, or a 3,4,5-tri-n-octyloxyphenylcarbonylamino group.

The aminocarbonylamino group is preferably a substituted or unsubstituted aminocarbonylamino group having 1 to 30 carbon atoms, e.g. a carbamoylamino group, an N,N-dimethylaminocarbonylamino group, an N,N-diethylaminocarbonylamino group, or a morpholinocarbonylamino group. In the aminocarbonylainino group, the term “amino” has the same meaning as “amino” in the above-described amino group.

The alkoxycarbonylamino group is preferably a substituted or unsubstituted alkoxycarbonylamino group having 2 to 30 carbon atoms, e.g. a methoxycarbonylamino group, an ethoxycarbonylamino group, a t-butoxycarbonylamino group, an n-octadecyloxycarbonylamino group, or an N-methyl-methoxycarbonylamino group.

The aryloxycarbonylamino group is preferably a substituted or unsubstituted aryloxycarbonylamino group having 7 to 30 carbon atoms, e.g. a phenoxycarbonylamino group, a p-chlorophenoxycarbonylamino group, or an m-n-octyloxyphenoxycarbonylamino group.

The sulfamoylamino group is preferably a substituted or unsubstituted sulfamoylamino group having 0 to 30 carbon atoms, e.g. a sulfamoylamino group, an N,N-dimethylaminosulfonylamino group, or an N-n-octylaminosulfonylamino group.

The alkyl- or aryl-sulfonylamino group is preferably a substituted or unsubstituted alkylsulfonylamino group having 1 to 30 carbon atoms, or a substituted or unsubstituted arylsulfonylamino group having 6 to 30 carbon atoms, e.g. a methylsulfonylamino group, a butylsulfonylamino group, a phenylsulfonylamino group, a 2,3,5-trichlorophenylsulfonylamino group, or a p-methylphenylsulfonylamino group.

The alkylthio group is preferably a substituted or unsubstituted alkylthio group having 1 to 30 carbon atoms, e.g. a methylthio group, an ethylthio group, or an n-hexadecylthio group.

The sulfamoyl group is preferably a substituted or unsubstituted sulfamoyl group having 0 to 30 carbon atoms, e.g. an N-ethylsulfamoyl group, an N-(3-dodecyloxypropyl)sulfamoyl group, an N,N-dimethylsulfamoyl group, an N-acetylsulfamoyl group, an N-benzoylsulfamoly group, or an N-(N′-phenylcarbamoyl)sulfamoyl group.

The alkyl- or aryl-sulfinyl group is preferably a substituted or unsubstituted alkylsulfinyl group having 1 to 30 carbon atoms, or a substituted or unsubstituted arylsulfinyl group having 6 to 30 carbon atoms, e.g. a methylsulfinyl group, an ethylsulfinyl group, a phenylsulfinyl group, or a p-methylphenylsulfinyl group.

The alkyl- or aryl-sulfonyl group is preferably a substituted or unsubstituted alkylsulfonyl group having 1 to 30 carbon atoms, or a substituted or unsubstituted arylsulfonyl group having 6 to 30 carbon atoms, e.g. a methylsulfonyl group, an ethylsulfonyl group, a phenylsulfonyl group, or a p-toluenesulfonyl group.

The acyl group is preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms and being bonded to said carbonyl group through a carbon atom, e.g. an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group.

The alkoxycarbonyl group is preferably a substituted or unsubstituted alkoxycarbonyl group having 2 to 30 carbon atoms, e.g. a methoxycarbonyl group, an ethoxycarbonyl group, a t-butoxycarbonyl group, or an n-octadecyloxycarbonyl group.

The aryloxycarbonyl group is preferably a substituted or unsubstituted aryloxycarbonyl group having 7 to 30 carbon atoms, e.g. a phenoxycarbonyl group, an o-chlorophenoxycarbonyl group, an m-nitrophenoxycarbonyl group, or a p-t-butylphenoxycarbonyl group.

The carbamoyl group is preferably a substituted or unsubstituted carbamoyl group having 1 to 30 carbon atoms, e.g. a carbamoyl group, an N-methylcarbamoyl group, an N,N-dimethylcarbamoyl group, an N,N-di-n-octylcarbamoyl group, or an N-(methylsulfonyl)carbamoyl group.

Examples of the aryl- or heterocyclic-azo group include a phenylazo group, a 4-methoxyphenylazo group, a 4-pivaloylaminophenylazo group, and a 2-hydroxy-4-propanoylphenylazo group.

Examples of the imido group include an N-succinimido group and an N-phthalimido group.

R¹ and R² each are preferably a substituted or unsubstituted alkyl group having 1 to 6 carbon atoms, more preferably a substituted or unsubstituted alkyl group having 1 to 4 carbon atoms, and most preferably an unsubstituted alkyl group having 1 to 4 carbon atoms.

R³ is preferably a substituted or unsubstituted alkyl group having 1 to 6 carbon atoms or a substituted or unsubstituted alkoxy group having 1 to 4 carbon atoms; more preferably a substituted or unsubstituted alkyl group having 1 to 4 carbon atoms or a substituted or unsubstituted alkoxy group having 1 to 3 carbon atoms; and most preferably an unsubstituted alkyl group having 1 to 4 carbon atoms or an unsubstituted alkoxy group having 1 to 3 carbon atoms.

R⁴ is preferably a methyl group.

The following is an explanation about a preferable combination of various groups (atoms) that the dye represented by formula (1) may have: A preferred compound is a compound in which at least one of the groups is the above-described preferable group. A more preferred compound is a compound in which many various groups are the above-described preferable groups. The most preferred compound is a compound in which all groups are the above-described preferable groups.

In a preferable combination, R¹ is a substituted or unsubstituted alkyl group having 1 to 4 carbon atoms; R² is a substituted or unsubstituted alkyl group having 1 to 4 carbon atoms; R³ is a substituted or unsubstituted alkyl group having 1 to 4 carbon atoms or a substituted or unsubstituted alkoxy group having 1 to 4 carbon atoms; and R⁴ is a methyl group or an ethyl group.

In a more preferable combination, R¹ is a substituted or unsubstituted alkyl group having 1 to 4 carbon atoms; R² is a substituted or unsubstituted alkyl group having 1 to 4 carbon atoms; R³ is a substituted or unsubstituted alkyl group having 1 to 3 carbon atoms or a substituted or unsubstituted alkoxy group having 1 to 3 carbon atoms; and R⁴ is a methyl group or an ethyl group.

In a most preferable combination, R¹ is an unsubstituted alkyl group having 1 to 4 carbon atoms; R² is an unsubstituted alkyl group having 1 to 4 carbon atoms; R³ is an unsubstituted alkyl group having 1 to 3 carbon atoms or an unsubstituted alkoxy group having 1 to 3 carbon atoms; and R⁴ is a methyl group.

### [Indoaniline Dye Represented by Formula (2)]

Hereinafter, the indoaniline dye represented by formula (2) will be described in detail.

In formula (2), R⁵ and R⁶ each independently represent a substituted or unsubstituted alkyl group having 1 to 8 carbon atoms; R⁷ represents a substituted or unsubstituted alkyl group having 1 to 8 carbon atoms or a substituted or unsubstituted alkoxy group having 1 to 8 carbon atoms; and R⁸ represents a methyl group or an ethyl group.

In formula (2), the substituent groups used when these substituent groups are additionally substituted are the same as the substituent groups that may be substituted additionally, as described above in formula (1).

R⁵ and R⁶ each are preferably a substituted or unsubstituted alkyl group having 1 to 6 carbon atoms, more preferably an unsubstituted alkyl group having 1 to 3 carbon atoms, and most preferably an unsubstituted alkyl group having 1 to 2 carbon atoms.

R⁷ is preferably a substituted or unsubstituted alkyl group having 1 to 6 carbon atoms or a substituted or unsubstituted alkoxy group having 1 to 4 carbon atoms; more preferably an unsubstituted alkyl group having 1 to 3 carbon atoms or an unsubstituted alkoxy group having 1 to 3 carbon atoms; and most preferably a methyl group, an ethyl group or an ethoxy group.

R⁸ is preferably a methyl group.

The following is an explanation about a preferable combination of various groups (atoms) that the dye represented by formula (2) may have: A preferred compound is a compound in which at least one of the groups is the above-described preferable group. A more preferred compound is a compound in which many various groups are the above-described preferable groups. The most preferred compound is a compound in which all groups are the above-described preferable groups.

In a preferable combination, R⁵ is a substituted or unsubstituted alkyl group having 1 to 4 carbon atoms; R⁶ is a substituted or unsubstituted alkyl group having 1 to 4 carbon atoms; R⁷ is a substituted or unsubstituted alkyl group having 1 to 4 carbon atoms or a substituted or unsubstituted alkoxy group having 1 to 4 carbon atoms; and R⁸ is a methyl group or an ethyl group.

In a more preferable combination, R⁵ is an unsubstituted alkyl group having 1 to 4 carbon atoms; R⁶ is an unsubstituted alkyl group having 1 to 4 carbon atoms; R⁷ is an unsubstituted alkyl group having 1 to 3 carbon atoms or an unsubstituted alkoxy group having 1 to 3 carbon atoms; and R⁸ is a methyl group or an ethyl group.

In a most preferable combination, R⁵ is a methyl group or an ethyl group; R⁶ is a methyl group or an ethyl group; R⁷ is a methyl group, an ethyl group or an methoxy group; and R⁸ is a methyl group.

In addition, preferable combination of the dyes represented by formula (1) and the dye represented by formula (2) is the combination of the dyes having the preferable groups described in respective formulae.

In the present invention, it is possible to obtain the advantageous effects of the present invention as far as at least one kind of dye selected from those represented by formula (1) and at least one kind of dye selected from those represented by formula (2) are used in combination. In addition, for increasing the advantageous effects of the present invention sufficiently by combination, the molecular weight of the indoaniline dye including its the skeleton and other regions is normally 600 or less, preferably 500 or less, and more preferably in the range of 250 to 420.

Hereinafter, specific examples of the indoaniline dyes represented by formula (1) or (2) according to the present invention are shown below, but the dyes that can be used in the present invention are not limited to the following specific examples.

TABLE 1
Indoaniline dyes represented by formula (1)

| No. | R¹ | R² | R³ | R⁴ |
|---|---|---|---|---|
| 1-1 | ethyl | ethyl | methyl | methyl |
| 1-2 | ethyl | ethyl | ethyl | methyl |
| 1-3 | ethyl | ethyl | n-propyl | methyl |
| 1-4 | ethyl | ethyl | n-butyl | methyl |
| 1-5 | n-propyl | n-propyl | methyl | methyl |
| 1-6 | n-propyl | n-propyl | ethyl | methyl |
| 1-7 | n-propyl | n-propyl | n-propyl | methyl |
| 1-8 | n-propyl | n-propyl | n-butyl | methyl |
| 1-9 | ethyl | ethyl | methoxy | methyl |
| 1-10 | ethyl | ethyl | ethoxy | methyl |
| 1-11 | ethyl | ethyl | n-propoxy | methyl |
| 1-12 | ethyl | ethyl | isopropoxy | methyl |
| 1-13 | ethyl | ethyl | n-butoxy | methyl |
| 1-14 | ethyl | ethyl | t-butoxy | methyl |
| 1-15 | 2-hydroxyethyl | 2-hydroxyethyl | methyl | methyl |
| 1-16 | 2-methoxyethyl | 2-methoxyethyl | methoxy | methyl |
| 1-17 | 2-methoxyethyl | 2-methoxyethyl | ethyl | methyl |
| 1-18 | 2-hydroxyethyl | 2-hydroxyethyl | ethoxy | methyl |
| 1-19 | 2-methoxyethyl | 2-methoxyethyl | n-propoxy | methyl |
| 1-20 | ethyl | ethyl | methyl | ethyl |

TABLE 2
Indoaniline dyes represented by formula (2)

| No | R⁵ | R⁶ | R⁷ | R⁸ |
|---|---|---|---|---|
| 2-1 | ethyl | ethyl | methyl | methyl |
| 2-2 | ethyl | ethyl | ethyl | methyl |
| 2-3 | ethyl | ethyl | n-propyl | methyl |
| 2-4 | ethyl | ethyl | n-butyl | methyl |
| 2-5 | n-propyl | n-propyl | methyl | methyl |
| 2-6 | n-propyl | n-propyl | ethyl | methyl |
| 2-7 | n-propyl | n-propyl | n-propyl | methyl |
| 2-8 | n-propyl | n-propyl | n-butyl | methyl |
| 2-9 | ethyl | ethyl | methoxy | methyl |
| 2-10 | ethyl | ethyl | ethoxy | methyl |
| 2-11 | ethyl | ethyl | n-propoxy | methyl |
| 2-12 | ethyl | ethyl | isopropoxy | methyl |
| 2-13 | ethyl | ethyl | n-butoxy | methyl |
| 2-14 | ethyl | ethyl | t-butoxy | methyl |
| 2-15 | 2-hydroxyethyl | 2-hydroxyethyl | methyl | methyl |
| 2-16 | 2-methoxyethyl | 2-methoxyethyl | methoxy | methyl |
| 2-17 | 2-methoxyethyl | 2-methoxyethyl | ethyl | methyl |
| 2-18 | 2-hydroxyethyl | 2-hydroxyethyl | ethoxy | methyl |
| 2-19 | 2-methoxyethyl | 2-methoxyethyl | n-propoxy | methyl |
| 2-20 | ethyl | ethyl | methyl | ethyl |

These indoaniline dyes can be prepared easily by a generally practiced method of oxidative coupling reaction of a N,N-dialkyl-p-phenylenediamine with a phenol derivative, for example by the method described in JP-A-61-35994.

The indoaniline-based dye represented by formula (1) or (2) is relatively superior both in transfer efficiency and fastness even when used alone, but has disadvantages that it is still insufficient in solubility when a high-concentration ink is produced and practically unsatisfactory in image evenness and frictional staining resistance, from the viewpoint of storage life of the ink sheet.

In addition, combined use of an other indoaniline-based dye different in structure from the dye according to the present invention for improvement in solubility also had a problem that the solubility may be improved but the light fastness, transfer density and color tone of the image to be formed are not satisfactory at high level.

The present invention provides an ink sheet and a heat-sensitive transfer recording method which can improve not only transfer density, light fastness and aging properties of ink sheet but also resistant to image defects caused by wrinkling of an ink sheet (ribbon wrinkle) during high-speed printing.

Although the reason for the improved resistance to ribbon wrinkling by combination of the dyes is not known, the ribbon wrinkling seems to be dependent on the surface states of the ink sheet and the image-receiving sheet during transfer, and the combination of the cyan dyes according to the present invention seems to modify the surface state during printing at the maximum transfer density.

### [Heat-Sensitive Transfer Sheet]

The indoaniline dye according to the present invention is preferably used as cyan color, among the three primary colors. The maximum absorption wavelength of the indoaniline dye according to the present invention is preferably 580 to 650 nm, more preferably 600 to 640 nm.

The heat-sensitive transfer sheet of the present invention can be produced by forming a dye layer, which contains at least the indoaniline dyes according to the present invention in combination, on a base sheet. The dye layer (dye-providing layer, heat-sensitive transfer layer, thermal transfer layer, or colorant layer) is formed by preparing an ink solution by dissolving these dyes with a binder in a solvent or dispersing the dyes in a solvent as fine particles; and applying the ink solution or dispersion on a support (base sheet); and then drying the resultant as needed.

### (Dye Layer)

The kind of the binder resin for use in the dye layer of the heat-sensitive transfer sheet of the present invention is not particularly limited, if the binder resin is highly heat resistant and does not inhibit transfer of the dye compound to the heat-sensitive transfer image-receiving sheet when heated.

Examples thereof include acrylic resins such as polyacrylonitrile, polyacrylate, and polyacrylamide; polyvinyl acetal resins such as polyvinyl acetoacetal, and polyvinyl butyral; cellulose resins such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate, cellulose nitrate, other modified cellulose resins, and nitrocellulose; other resins such as polyurethane resin, polyamide resin, polyester resin, polycarbonate resin, phenoxy resin, phenol resin, and epoxy resin; and various elastomers. The dye layer may be made of at least one resin selected from the above-mentioned group.

These may be used alone, or two or more thereof may be used in the form of a mixture or copolymer. These may be crosslinked with various crosslinking agents.

The binder in the invention is preferably a cellulose resin or a polyvinyl acetal resin, more preferably a polyvinyl acetal resin. In the invention, the binder resin is in particular preferably a polyvinyl acetoacetal resin, or a polyvinyl butyral resin.

The ratio A of the acetoacetal groups in the polyvinyl acetal resin above is defined as follows, specifically when the molar ratio (mole %) of the acetoacetal groups with respect to the total molar number of the acetoacetal, butyral and OH groups is designated as A. In this case, A is preferably 50 mole % or more and 90 mole % or less, more preferably 60 mole % or more and 90 mole % or less. The value A can be calculated from the integral intensity peak ratio obtained by NMR measurement.

When the indoaniline dyes represented by formulae (1) and (2) for the dye layer are mixed, the ratio thereof (dye represented by formula (1): dye represented by formula (2)) is generally, preferably in the range of 10:90 to 90:10 by mass, although the ratio are changed depending on the kind of selected respective dyes. An excessively large ratio of one dye may lead to insufficient improvement in solubility and deterioration in storability of the ink sheet.

The indoaniline dye according to the present invention may be used with another cyan dye in the range that does not impair the advantageous effects of the present invention. The content of the another cyan dye is 30 part or less by mass, preferably 20 part or less by mass, more preferably 10 part or less by mass, and particularly preferably 5 part or less by mass, in which a total amount of two kinds of the indoaniline dye according to the present invention is 100 parts by mass. Specific examples of the another cyan dyes include C.I. Solvent Blue 36 and 63, C.I. Disperse Blue 35 and 354, and the like.

The content of each of the compounds represented by formulae (1) and (2) in the dye layer is preferably 0.03 to 1.0 g/m², and more preferably 0.1 to 0.6 g/m², respectively. The thickness of the dye layer is preferably 0.2 to 5 μm and more preferably 0.4 to 2 μm.

The dye layer according to the present invention is preferably used as a cyan dye layer. In order to form a color image, it is preferred that dye (sub)layers in individual colors of yellow, magenta and cyan, and an optional dye (sub)layer in black are repeatedly painted onto a single support in area order in such a manner that the colors are divided from each other. An example of the dye layer is an embodiment wherein dye (sub)layers in individual colors of yellow, magenta and cyan are painted onto a single support along the long axial direction thereof in area order, correspondingly to the area of the recording surface of the above-mentioned heat-sensitive transfer image-receiving sheet, in such a manner that the colors are divided from each other. Another example thereof is an embodiment wherein not only the three dye (sub)layers but also a dye (sub)layer in black and/or a transferable protective layer are painted in such a manner that these (sub)layers are divided from each other. This embodiment is preferred.

In the case of adopting such an embodiment, it is preferred to give marks to the heat-sensitive transfer sheet in order to inform the printer about starting point of the individual colors. Such painting repeated in area order makes it possible that a single heat-sensitive transfer sheet is used to form an image on the basis of transfer of dyes and further laminate a protective layer on the image.

In the present invention, however, the manner in which the dye layer is formed is not limited to the above-mentioned manners. A sublimation heat-transferable dye layer and a heat-melt transferable ink layer may be together formed. A dye layer in a color other than yellow, magenta, cyan and black is formed, or other modifications may be made. The form of the heat-sensitive transfer sheet including the dye layer may be a longitudinal form, or a one-piece form.

The dye layer may have a mono-layered structure or a multi-layered structure. In the case of the multi-layered structure, the individual layers constituting the dye layer may be the same or different in composition.

### (Dye Barrier Layer)

In the heat-sensitive transfer sheet of the present invention, a dye barrier layer may be formed between the dye layer and the base sheet.

### (Treatment for Easy Adhesion)

The surface of the base film (base sheet) may be subjected to treatment for easy adhesion to improve the wettability and the adhesive property of the coating liquid. Examples of the treatment include corona discharge treatment, flame treatment, ozone treatment, ultraviolet treatment, radial ray treatment, surface-roughening treatment, chemical agent treatment, vacuum plasma treatment, atmospheric plasma treatment, primer treatment, grafting treatment, and other known surface modifying treatments.

An easily-adhesive layer may be formed on the base film by coating. Examples of the resin used in the easily-adhesive layer include polyester resins, polyacrylate resins, polyvinyl acetate resins, vinyl resins such as polyvinyl chloride resin and polyvinyl alcohol resin, polyvinyl acetal resins such as polyvinyl acetoacetal and polyvinyl butyral, polyether resins, polyurethane resins, styrene acrylate resins, polyacrylamide resins, polyamide resins, polystyrene resins, polyethylene resins, and polypropylene resins.

When a film used for the base film is formed by melt extrusion, it is allowable to subject a non-drawn film to coating treatment followed by drawing treatment.

The above-mentioned treatments may be used in combination of two or more thereof.

### (Transferable Protective Layer Laminate)

In the present invention, a transferable protective layer laminate is preferably formed in area order onto the heat-sensitive transfer sheet. The transferable protective layer laminate is used to protect a heat-transferred image with a protective layer composed of a transparent resin, thereby to improve durability such as scratch resistance, light-fastness, and resistance to weather. This laminate is effective for a case where the transferred dye is insufficient in image durabilities such as light resistance, scratch resistance, and chemical resistance in the state that the dye is naked in the surface of an image-receiving sheet.

The transferable protective layer laminate can be formed by forming, onto a base film, a releasing layer, a protective layer and an adhesive layer in this order (i.e., in the layer-described order) successively. The protective layer may be formed by plural layers. In the case where the protective layer also has functions of other layers, the releasing layer and the adhesive layer can be omitted. It is also possible to use a base film on which an easy adhesive layer has already been formed.

### (Transferable Protective Layer)

As a transferable protective layer-forming resin, preferred are resins that are excellent in scratch resistance, chemical resistance, transparency and hardness. Examples of the resin include polyester resins, polystyrene resins, acrylic resins, polyurethane resins, acrylic urethane resins, silicone-modified resins of the above-described resins, ultraviolet-shielding resins, mixtures of these resins, ionizing radiation-curable resins, and ultraviolet-curing resins. Particularly preferred are polyester resins and acrylic resins.

These resins may be crosslinked with various crosslinking agents.

### (Transferable Protective Layer Resin)

As the acrylic resin, use can be made of polymers derived from at least one monomer selected from conventionally known acrylate monomers and methacrylate monomers. Other monomers than these acrylate-series monomers, such as styrene and acrylonitrile may be co-polymerized with said acryl-series monomers. A preferred monomer is methyl methacrylate. It is preferred that methyl methacrylate is contained in terms of preparation mass ratio of 50 mass % or more in the polymer.

The acrylic resin in the invention preferably has a molecular weight of 20,000 or more and 100,000 or less. The acrylic resin having excessively small molecular weight gives an oligomer during synthesis, prohibiting stabilized characteristics, while the acrylic resin having excessively large molecular weight leads to foil-off of the sheet during protective layer transfer.

The polyester resin in the invention may be a saturated polyester resin known in the prior art. As the above-described polyester resin, a preferable glass transition temperature ranges from 50° C. to 120° C., and a preferable molecular weight ranges from 2,000 to 40,000. A molecular weight ranging from 4,000 to 20,000 is more preferred, because so-called “foil-off” properties at the time of transfer of the protective layer are improved.

### (Ultraviolet Absorbent)

In the protective layer transferring sheet in the invention, an ultraviolet absorbent may be incorporated into the protective layer and/or the adhesive layer. The ultraviolet absorbent may be an inorganic ultraviolet absorbent or organic ultraviolet absorbent known in the prior art.

As the organic ultraviolet absorbing agents, use can be made of non-reactive ultraviolet absorbing agents such as salicylate-series, benzophenone-series, benzotriazole-series, triazine-series, substituted acrylonitrile-series, and hindered amine-series ultraviolet absorbing agents; and copolymers or graft polymers of thermoplastic resins (e.g., acrylic resins) and activated products obtained by introducing to the above-described non-reactive ultraviolet absorbing agents; addition-polymerizable double bonds originated from a vinyl group, an acryroyl group, a methacryroyl group, or the like, or alternatively by introducing thereto other types of groups such as an alcoholic hydroxyl group, an amino group, a carboxyl group, an epoxy group, and an isocyanate group. In addition, disclosed is a method of obtaining ultraviolet-shielding resins by the steps of dissolving ultraviolet absorbing agents in a monomer or oligomer of the resin to be used in the protective layer, and then polymerizing the monomer or oligomer (JP-A-2006-21333). In this case, the ultraviolet absorbing agents may be non-reactive.

Of these ultraviolet absorbing agents, preferred are benzophenone-series, benzotriazole-series, and triazine-series ultraviolet absorbing agents. It is preferred that these ultraviolet absorbers are used in combination so as to cover an effective ultraviolet absorption wavelength region according to characteristic properties of the dye that is used for image formation. Besides, in the case of non-reactive ultraviolet absorbers, it is preferred to use a mixture of two or more kinds of ultraviolet absorbers each having a different structure from each other so as to prevent the ultraviolet absorbers from precipitation.

Examples of commercially available ultraviolet absorbing agents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISOUB 200 (trade name, manufactured by Sumitomo Chemical Co., Ltd.), BIOSOUP 520 (trade name, manufactured by KYODO CHEMICAL CO., LTD.), and ADKSTAB LA-32 (trade name, manufactured by ADEKA).

### (Formation of the Transferable Protective Layer)

The method for forming the protective layer, which depends on the kind of the resin to be used, may be the same method for forming the dye layer. The protective layer preferably has a thickness of 0.5 to 10 μm.

### (Releasing Layer)

In a case where the protective layer is not easily peeled from the support in the protective layer transferring sheet when the image is thermally transferred, a releasing layer may be formed between the support and the protective layer. A peeling layer may be formed between the transferable protective layer and the releasing layer. The releasing layer may be formed by painting a coating liquid by a method known in the prior art, such as gravure coating or gravure reverse coating, and then drying the painted liquid. The coating liquid contains at least one selected from, for example, waxes, silicone waxes, silicone resins, fluorine-contained resins, acrylic resins, polyvinyl alcohol resins, cellulose derivative resins, urethane resins, vinyl acetate resins, acryl vinyl ether resins, maleic anhydride resins, and copolymers of these resins. Of these resins, preferred are: acrylic resins, such as resin obtained by homopolymerizing a (meth)acrylic monomer such as acrylic acid or methacrylic acid, or obtained by copolymerizing a methacrylic monomer with a different monomer; or cellulose derivative resins. They are each excellent in adhesive property to the support, and releasing ability from the protective layer.

These resins may be crosslinked with various crosslinking agents. Moreover, ionizing radiation curable resin and ultraviolet curable resin may be used.

The releasing layer may be appropriately selected from a releasing layer which is transferred to a transferred-image-receiving member when the image is thermally transferred, a releasing layer which remains on the support side at that time, a releasing layer which is broken out by aggregation at that time, and other releasing layers. A preferred embodiment of the invention is an embodiment wherein the releasing layer remains on the support side at the time of the thermal transfer and the interface between the releasing layer and the thermally transferable protective layer becomes a protective layer surface after the thermal transfer since the embodiment is excellent in surface gloss, the transfer stability of the protective layer, and others. The method for forming the releasing layer may be a painting method known in the prior art. The releasing layer preferably has a thickness of about 0.5 to 5 μm in the state that the layer is dried.

### (Adhesive Layer)

An adhesive layer may be formed, as the topmost layer of the transferable protective layer laminate, on the topmost surface of the protective layer. This makes it possible to make the adhesive property of the protective layer to a transferred-image-receiving member good.

### (Heat-Resistant Lubricating (Sliding) Layer)

The heat-sensitive transfer sheet according to the present invention preferably has a heat-resistant lubricating layer on the face of the base sheet opposite to the face carrying the dye layer applied (opposite face), i.e., the face in contact with the thermal head and others. Also in the case of a protective layer transferring sheet, a heat-resistant lubricating layer is preferably formed on the face of the base sheet opposite to the face carrying the applied transfer protective layer (opposite face), i.e., the face in contact with the thermal head and others.

The opposite face of the base sheet of heat-sensitive transfer sheet, when heated in direct contact with a heating device such as thermal head, often results in thermal fusion. The friction between them also becomes larger, making it difficult to convey the heat-sensitive transfer sheet smoothly during printing.

The heat-resistant lubricating layer, which is provided for the purpose of making the heat-sensitive transfer sheet resistant to the heat energy of the thermal head, prevents the thermal fusion and enables smooth travel of the heat-sensitive transfer sheet. There is an increasing need for such a layer in the recent trend toward increase in printing speed of printers and also in heat energy of the thermal heads.

The heat-resistant lubricating layer is prepared by adding a lubricant, a releasing agent, a surfactant, inorganic particles, organic particles, pigments, and others to a binder and applying the mixture. An intermediate layer may be formed between the heat-resistant lubricating layer and the base sheet. As the intermediate layer, a layer consisting of inorganic fine particles and a water-soluble resin or an emulsifiable hydrophilic resin is disclosed.

Any known high heat-resistant resin may be used as the binder. Examples thereof include natural or synthetic resins including cellulosic resins such as ethylcellulose, hydroxycellulose, hydroxypropylcellulose, methylcellulose, cellulose acetate, cellulose acetate butyrate, cellulose acetate propionate and nitrocellulose; vinyl resins such as polyvinylalcohol, polyvinyl acetate, polyvinyl butyral, polyvinyl acetal, polyvinyl acetoacetal resins, vinyl chloride-vinyl acetate copolymers and polyvinyl pyrrolidone; acrylic resins such as polymethyl methacrylate, polyethyl acrylate, polyacrylamide, and acrylonitrile-styrene copolymers; polyamide resins, polyimide resins, polyamide-imide resins, polyvinyltoluene resins, coumarone-indene resins, polyester resins, polyurethane resins, polyether resins, polybutadiene resins, polycarbonate resins, chlorinated polyolefin resins, fluoroplastics, epoxy resins, phenol resins, silicone resins, and silicone-modified or fluorine-modified urethanes, and these resins may be used alone or in combination.

Known is a method of crosslinking the heat-resistant lubricating layer by irradiation of ultraviolet ray or electron beam for improvement in heat resistance. The resin may be crosslinked alternatively by heating in the presence of a crosslinking agent. A catalyst may be added thereto during crosslinking. The crosslinking agent is, for example, a polyisocyanate, and a resin having hydroxyl-like functional groups is suitable for that purpose. JP-A-62-259889 discloses that a heat-resistant lubricating layer is formed by adding fillers such as an alkali-metal salt or alkali-earth salt of phosphate ester and calcium carbonate to the reaction product of polyvinylbutyral and an isocyanate compound. Alternatively, JP-A-6-99671 discloses that the heat-resistant lubricating layer is obtained by reacting a heat-resistant lubricating layer-forming polymer compound with an amino group-containing silicone compound and an isocyanate compound having two or more isocyanate groups in the molecule. Use of these methods is preferable in the present invention.

For sufficient exhibition of its favorable function, the heat-resistant lubricating layer may contain additives such as lubricants, plasticizers, stabilizers, fillers, and head deposit-removing fillers.

Examples of the lubricants include inorganic solid lubricants including fluorides such as calcium fluoride, barium fluoride and graphite fluoride, sulfides such as molybdenum disulfide, tungsten disulfide and iron sulfide, oxides such as lead oxide, alumina and molybdenum oxide, graphite, mica, boron nitride, and clays (talc, acid clay, etc.); organic resins such as fluoroplastics, silicone resins and silicone oils; metal soaps such as metal stearate salts; various waxes such as polyethylene waxes and paraffin waxes; surfactants such as anionic surfactants, cationic surfactants, amphoteric surfactants, nonionic surfactants and fluorochemical surfactants; and the like.

Also known is a method of using a phosphate ester-based surfactant such as an alkylphosphoric monoester and a zinc salt of alkylphosphoric diester or a neutralized phosphoric ester-based surfactant, a method of using a neutralizing agent such as magnesium hydroxide and others, and these phosphate esters are preferably contained in the present invention.

Examples of the other additives include fine particles of higher fatty acid alcohols, organopolysiloxanes, organic carboxylic acids and the derivatives thereof, inorganic compounds such as talc and silica, and the like.

Among them, use of inorganic particles is particularly preferable.

More specifically, the hardness of the inorganic particles is preferably 3 to 7, more preferably 3 to 6 and still more preferably 3.5 to 5.5, as so-called Mohs' hardness. Inorganic particles having excessively small Mohs' hardness cannot prevent deformation of the ink sheet during high-speed printing, while those having excessively large Mohs' hardness leads to scratching of the thermal printer head.

The Mohs' hardness, which was devised by a mineralogist in Germany Friedrich Mohs, is a numerical value of hardness as determined based on scratching caused by standard substances. There are 1 to 10 standard substances from soft to hard, and specifically, the standard substance 1 is talc; 2 is gypsum; 3 is calcite; 4 is fluorite; 5 is apatite; 6 is orthoclase; 7 is quartz; 8 is topaz; 9 is corundum; and 10 is diamond. The Mohs' hardness is only a relative value and not an absolute value.

Any known inorganic particles may be used as inorganic particles having a Mohs' hardness of 3 to 7, and examples thereof include calcium carbonate (Mohs' hardness: 3), dolomite (MgCa(CO₃)₂) (Mohs' hardness: 3.5 to 4), magnesium oxide (Mohs' hardness: 4), magnesium carbonate (Mohs' hardness: 3.5 to 4.5) and silica (Mohs' hardness7). Among the inorganic particles above, magnesium oxide and magnesium carbonate are more preferably, and magnesium oxide is still more preferable.

The average particle diameter of the inorganic particles contained in the heat-resistant lubricating layer is preferably 0.3 μm to 5 μm. In the present invention, particles having excessively small average particle diameter are not effective in preventing deformation of the ink sheet during high-speed printing and also in reducing materials adhering to the thermal printer head, while particles having excessively large average particle diameter leads to rather expanded deformation of the ink sheet during high-speed printing and simultaneously increased abrasion and scratching of the thermal printer head. Scratching and abrasion of the thermal printer head, specifically those of the insulating layer protecting the electrode heat-generating region on the thermal printer head surface, leads to shortened lifetime of the thermal printer head. The average particle diameter is more preferably 0.3 μm to 4.5 μm and still more preferably 0.4 μm to 4 μm. The average particle diameter is a value as determined by laser diffraction/scattering method. Spatial distribution of the diffracted and scattered light intensity obtained by photoirradiation of a particle varies according to the particle size, and thus, it is possible to determine the particle size distribution by analyzing the spatial distribution of the diffracted and scattered light intensity. Such a technique is established as an analysis method of laser beam scattering. A device used for the measurement may be a commercially available product, such as SALD series manufactured by Shimadzu Corp. and LA series manufactured by Horiba, Ltd.

As for the shape of the inorganic particle, the ratio of the maximum width to the sphere-equivalent diameter is preferably 1.5 to 50. Particles having excessively small ratio are almost not effective in preventing materials adhering to the thermal printer head and occasionally damage the thermal printer head by scratching. Particles having excessively large ratio, for example, in case where spicular inorganic particles having a needle diameter of 0.12 μm and a length of 88 μm has the ratio of approximately 70, are more fragile under external stress and thus, may be hardly contained in the heat-resistant lubricating layer in their original shapes.

The ratio of the maximum width to the sphere-equivalent diameter of an inorganic particle can be determined by observation of the inorganic particle with a scanning electron microscope (“SEM”). Specific procedures are as follows.

An inorganic particle is observed from various observation angles with a SEM, and measured its shape, length and thickness.

The particle volume is calculated from the shape and the size thus measured, and the sphere-equivalent diameter is calculated. The sphere-equivalent diameter is the diameter of a sphere having a particle volume equal to the calculated particle volume. The maximum width of the particle is determined from the measured length and thickness. The maximum width of particle is the maximum value of the length between any two points on the particle surface. When the inorganic particle is columnar, the maximum width corresponds to the height of the column. When the inorganic particle is a needle form, the maximum width corresponds to the length of the needle. When the inorganic particle is tabular, the maximum width corresponds to the largest width of the main plane(s).

The ratio can be obtained by dividing the maximum width of individual particle thus obtained by the sphere-equivalent diameter. When the particulate form is spherical, the maximum width and the sphere equivalent diameter are equal to each other so that the ratio turns 1. When the particulate form is cubic, the value of the ratio is about 1.4. As the particulate form departs more largely from a sphere, the value of the ratio becomes larger.

When particles contain therein pores, the volume of the particles cannot be precisely calculated. In this case, however, the ratio is obtained by making calculation on the supposition that the particles have no pores.

The ratio of the maximum width of the individual inorganic particle contained in the heat-resistant lubricating layer to the sphere equivalent diameter thereof is varied in accordance with the selected particle. However, the average ratio of the individual particles is preferable in the range of 1.5 to 50 for 50 mass % or more of all the inorganic particles having a Mohs' hardness of 3 to 7 in the heat-resistant lubricating layer, more preferably in the range of 1.5 to 50 for 80 mass % or more thereof, and most preferably in the range of 1.5 to 50 for 90 mass % or more thereof.

This ratio is more preferably 1.8 to 45, and still more preferably 2 to 40.

The heat-resistant lubricating layer is formed by adding additives to the binder exemplified above, dissolving or dispersing the resultant into a solvent to prepare a coating liquid, and then applying the coating liquid by a known method such as gravure coating, roll coating, blade coating, or wire bar coating. The film thickness of the heat-resistant lubricating layer is preferably about 0.1 to 10 μm, and more preferably about 0.5 to 5 μm.

### (Base Sheet)

The base sheet in the heat-sensitive transfer sheet according to the present invention is not particularly limited, and any known sheet can be used, if it has required heat resistance and mechanical strength.

Examples of the base sheet include polyamide, polyimide and polyester films.

The thickness of the base sheet may be appropriately altered according to the material of the base sheet so that the desirable mechanical strength and heat resistance become optimum, but is preferably 1 to 100 μm. It is more preferably about 2 to 50 μm and more preferably about 3 to 10 μm.

### (Heat-Sensitive Transfer Recording Method)

The heat-sensitive transfer sheet of the present invention preferably forms an image by using the heat-sensitive transfer image-receiving sheet. The heat-sensitive transfer image-receiving sheet for use in the present invention is preferably a sheet having an ink receiving layer (receptor layer) containing a polymer formed on a support. Any known support may be used as the support. In particular, a waterproof support is preferably used. Use of such a waterproof support prevents adsorption of water in the support and prevents change in properties of the receiving layer over time. For example, a coated paper, a laminate paper, or a synthetic paper may be used as the waterproof support. In particular, a laminate paper is preferable. Examples of the preferable polymers include vinyl resins such as polyvinyl acetate, ethylene vinyl acetate copolymers, vinyl chloride vinyl acetate copolymers, vinyl chloride acrylic ester copolymers, vinyl chloride methacrylic ester copolymers, polyacrylic esters, polystyrene, and acrylic polystyrene; acetal resins such as polyvinylformal, polyvinylbutyral, and polyvinyl acetal; polyester resins such as polyethylene terephthalate and polybutylene terephthalate; polycarbonate resins, cellulosic resins, polyolefin resins such as polypropylene; polyamide resins such as urea resins, melamine resins and benzoguanamine resins; and the like. These resins may be used optionally blending with each other, if they are compatible with each other.

It is further preferable, among these polymers, to use a polycarbonate, a polyester, a polyurethane, a polyvinyl chloride or a copolymer of vinyl chloride, a styrene-acrylonitrile copolymer, a polycaprolactone or a mixture of two or more of these. It is particularly preferable to use a polyester, a polyvinyl chloride or a copolymer of vinyl chloride or a mixture of two or more of these.

In the heat-sensitive transfer recording method of the present invention, the image can be formed by using a commercially available thermal transfer printer.

In the present invention, the line speed of printer is preferably 0.50 msec/line or more and 0.73 msec/line or less, and more preferably 0.65 msec/line or more and 0.73 msec/line or less. Excessive low line speed is undesirable because it causes problems such as ribbon breakage. While a line speed of more than 0.73 msec/line is undesirable because it leads to increase the occurrence of ribbon wrinkling.

The line speed of printer is defined by the period needed for one line of pixel to be printed in the direction perpendicular to the conveying direction of the print.

According to the present invention, it is possible to provide a heat-sensitive transfer sheet (an ink sheet) and a heat-sensitive transfer recording method not only excellent in transfer density, light fastness and storability of an ink sheet, which are demanded for the conventional heat-sensitive transfer sheets, but also effective in improving image defects due to wrinkling of ink sheet (ribbon wrinkling) during high-speed printing.

The present invention will be described in more detail based on the following examples, but the materials, usage amounts, rates, processing method, processing steps and the like described in Examples may be appropriately altered in the range that does not departing from the scope of the present invention. Therefore, the invention is not intended to be limited thereto. In the following Examples, the terms “part” and “%” are values by mass, unless they are indicated differently in particular.

### EXAMPLES

### Example 1

### (Production of Heat-Sensitive Transfer Sheets)

A polyester film 6.0 μm in thickness (trade name: Diafoil K200E-6F, manufactured by MITSUBISHI POLYESTER FILM CORPORATION), that was subjected to an adhesion-treatment on one surface of the film, was used as a support. The following heat-resistant lubricating layer coating liquid was applied onto the support on the other surface that was not subjected to the adhesion-treatment, so that the coating amount based on the solid content after drying would be 1 g/m². After drying, the coated film was hardened by heat at 60° C.

A heat-sensitive transfer sheet A was prepared by coating the following coating liquids on the easy adhesion layer coating side of the thus-prepared polyethylene film so that individual dye layers in yellow, magenta and cyan (heat-sensitive transfer layers; hereinafter, refer to as “dye layer”), and a protective layer could be disposed in area order. The solid coating amount in each of the dye layers (heat-sensitive transfer layers) was set to 0.8 g/m².

In the formation of the transferable protective layer laminate, a releasing-layer-coating liquid was coated, a protective-layer-coating liquid was coated thereon, the resultant was dried, and then an adhesive-layer-coating liquid was coated thereon.

| | |
|---|---|
| Heat-resistant-lubricating-layer-coating liquid 1 | |
| Acrylic polyol resin | 26.0 mass parts |
| Phosphate ester | 9.8 mass parts |
| (Plysurf A208N, manufactured by Dai-ichi Kogyo | |
| Seiyaku Co., Ltd.) | |
| Magnesium oxide | 0.5 mass part |
| (Mohs' hardness: 4, average diameter: 1.2 μm, | |
| average of particle maximum width/sphere- | |
| equivalent diameter: 4.4) | |
| Zinc stearyl phosphate | 0.6 mass part |
| Zinc stearate | 0.6 mass part |
| Polyisocyanate (50% solution) | 17.5 mass parts |
| (trade name: BIRNOCK D-750, manufactured by | |
| Dainippon Ink &Chemicals, Inc.) | |
| Methyl ethyl ketone/toluene mixed solvent | 70 mass parts |
| Heat-resistant-lubricating-layer-coating liquid 2 | |
| Acrylic polyol resin | 26.0 mass parts |
| Phosphate ester | 9.8 mass parts |
| (Plysurf A208N, manufactured by Dai-ichi Kogyo | |
| Seiyaku Co., Ltd.) | |
| Zinc stearyl phosphate | 0.6 mass part |
| Zinc stearate | 0.6 mass part |
| Polyisocyanate (50% solution) | 17.5 mass parts |
| (trade name: BIRNOCK D-750, manufactured by | |
| Dainippon Ink &Chemicals, Inc.) | |
| Methyl ethyl ketone/toluene mixed solvent | 70 mass parts |
| Yellow-dye-layer-coating liquid | |
| 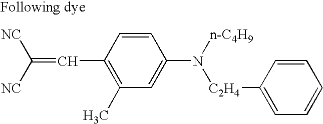 | 3.9 mass parts |
| 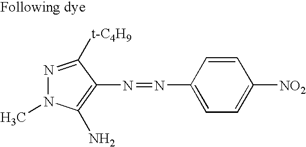 | 3.9 mass parts |
| Polyvinyl acetal resin | 8.2 mass parts |
| (trade name: ESLEC KS-1, manufactured by Sekisui | |
| Chemical Co., Ltd.; ratio A of the acetoacetal groups | |
| in the resin: 82 mol %) | |
| Releasing agent | 0.05 mass part |
| (trade name: X-22-3000T, manufactured by Shin-Etsu | |
| Chemical Co., Ltd.) | |
| Releasing agent | 0.03 mass part |
| (trade name: TSF4701, manufactured by MOMENTIVE | |
| Performance Materials Japan LLC.) | |
| Matting agent | 0.15 mass part |
| (trade name: Flo-thene UF, manufactured by Sumitomo | |
| Seika Chemicals Co., Ltd.) | |
| Methyl ethyl ketone/toluene (2 parts/1 part) | 84 mass parts |
| Magenta-dye-layer-coating liquid | |
| 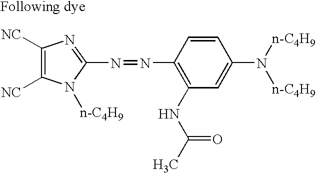 | 3.9 mass parts |
| 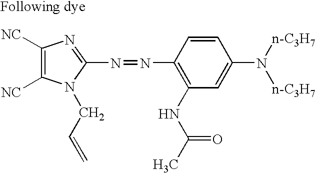 | 3.9 mass parts |
| Polyvinyl acetal resin | 8.2 mass parts |
| (trade name: ESLEC KS-1, manufactured by Sekisui | |
| Chemical Co., Ltd.; ratio A of the acetoacetal groups | |
| in the resin: 82 mol %) | |
| Releasing agent | 0.05 mass part |
| (trade name: X-22-3000T, manufactured by Shin-Etsu | |
| Chemical Co., Ltd.) | |
| Releasing agent | 0.03 mass part |
| (trade name: TSF4701, manufactured by MOMENTIVE | |
| Performance Materials Japan LLC.) | |
| Matting agent | 0.15 mass part |
| (trade name: Flo-thene UF, manufactured by Sumitomo | |
| Seika Chemicals Co., Ltd.) | |
| Methyl ethyl ketone/toluene (2 parts/1 part) | 84 mass parts |
| Cyan-dye-layer-coating liquid (C) | |
| Compound C-A (shown in Table 3) | 3.9 mass parts |
| Compound C-B (shown in Table 3) | 3.9 mass parts |
| Polyvinyl acetal resin | 8.2 mass parts |
| (trade name: ESLEC KS-1, manufactured by Sekisui | |
| Chemical Co., Ltd.; ratio A of the acetoacetal groups | |
| in the resin: 82 mol %) | |
| Releasing agent | 0.05 mass part |
| (trade name: X-22-3000T, manufactured by Shin-Etsu | |
| Chemical Co., Ltd.) | |
| Releasing agent | 0.03 mass part |
| (trade name: TSF4701, manufactured by MOMENTIVE | |
| Performance Materials Japan LLC.) | |
| Matting agent | 0.15 mass part |
| (trade name: Flo-thene UF, manufactured by Sumitomo | |
| Seika Chemicals Co., Ltd.) | |
| Methyl ethyl ketone/toluene (1 part/1 part) | 84 mass parts |

The dyes shown in the following Table 3 were used as the combination of compounds C-A and C-B. The compounds “1-1” to “1-6” and “2-1” to “2-20” shown in Table 3 each correspond to the exemplified dyes “1-1” to “1-6” and “2-1” to “2-20” shown in the above Tables 1 and 2.

In the heat-sensitive transfer sheet 6 or 7, the dye 2-1 or 1-5 was only used as the compound C-A, respectively. In those sheets, the dye 2-1 or 1-5 was used in an amount of 7.8 mass parts.

TABLE 3

| Sheet No. | C-A | C-B |
|---|---|---|
| Heat-sensitive transfer sheet 1 | C1 | C2 |
| Heat-sensitive transfer sheet 2 | C3 | C4 |
| Heat-sensitive transfer sheet 3 | 2-1 | C5 |
| Heat-sensitive transfer sheet 4 | 2-1 | C6 |
| Heat-sensitive transfer sheet 5 | 2-1 | C7 |
| Heat-sensitive transfer sheet 6 | 2-1 | — |
| Heat-sensitive transfer sheet 7 | 1-5 | — |
| Heat-sensitive transfer sheet 8 | 2-1 | 1-5 |
| Heat-sensitive transfer sheet 9 | 2-2 | 1-1 |
| Heat-sensitive transfer sheet 10 | 2-9 | 1-2 |
| Heat-sensitive transfer sheet 11 | 2-20 | 1-6 |
| Heat-sensitive transfer sheet 12 | 2-3 | 1-5 |
| Heat-sensitive transfer sheet 13 | 2-4 | 1-1 |
| Heat-sensitive transfer sheet 14 | 2-5 | 1-2 |
| Heat-sensitive transfer sheet 15 | 2-6 | 1-6 |

The structural formulae of the compounds C1 to C7 in Table 3 above are shown below.

### Comparative Cyan Dye (C1)

### (Exemplified Compound 1-1 Described in JP-B-5-15198)

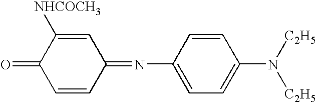

### Comparative Cyan Dye (C2)

### (Exemplified Compound 1-2 Described in JP-B-5-15198)

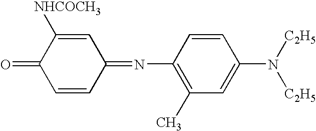

### Comparative Cyan Dye (C3)

### (Exemplified Compound 1 in Table 2 Described in JP-A-2-74683)

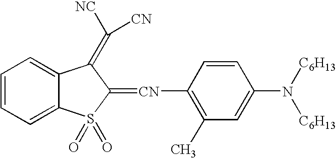

### Comparative Cyan Dye (C4)

### (Exemplified Compound 11 in Table 1 Described in JP-A-2-74683)

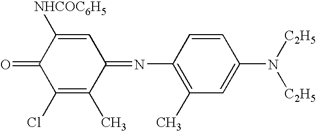

### Comparative Cyan Dye (C5)

### (Exemplified Compound 2-7 Described in JP-A-10-181222)

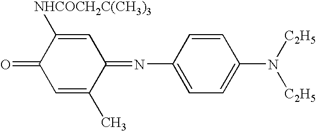

### Comparative Cyan Dye (C6)

### (C.I. Solvent Blue 36)

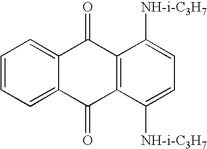

### Comparative Cyan Dye (C7)

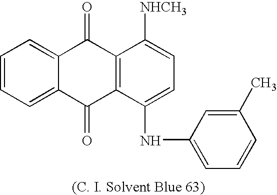

### (Transfer Protective Layer Laminate)

On the polyester film coated with the dye layers as described above, coating solutions of a releasing layer, a protective layer and an adhesive layer each having the following composition was coated, to form a transfer protective layer laminate. Coating amounts of the releasing layer, the protective layer and the adhesive layer after drying were 0.3 g/m², 0.5 g/m² and 2.2 g/m², respectively.

| | |
|---|---|
| Releasing-layer-coating liquid | |
| Modified cellulose resin | 5.0 mass parts |
| (trade name: L-30, manufactured by DAICEL | |
| CHEMICAL INDUSTRIES, LTD.) | |
| Methyl ethyl ketone | 95.0 mass parts |
| Protective-layer-coating liquid | |
| Acrylic resin solution (Solid content: 40%) | 90 mass parts |
| (trade name: UNO-1, manufactured by Gifu Ceramics | |
| Limited) | |
| Methanol/isopropanol (1 part/1 part) | 10 mass parts |
| Adhesive-layer-coating liquid | |
| Acrylic resin | 25 mass parts |
| (trade name: DIANAL BR-77, manufactured by | |
| MITSUBISHI RAYON CO., LTD.) | |
| The following ultraviolet absorber UV-1 | 1 mass part |
| The following ultraviolet absorber UV-2 | 2 mass parts |
| The following ultraviolet absorber UV-3 | 1 mass part |
| The following ultraviolet absorber UV-4 | 1 mass part |
| PMMA fine particles | 0.4 mass part |
| (polymethyl methacrylate fine particles) | |
| Methyl ethyl ketone/toluene (2 parts/1 part) | 70 mass parts |

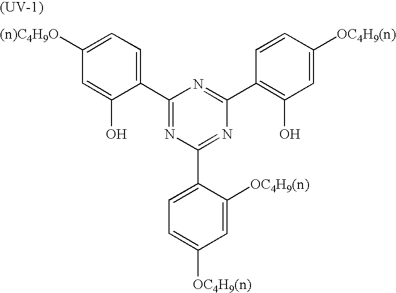

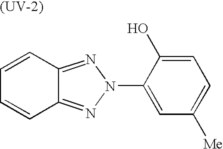

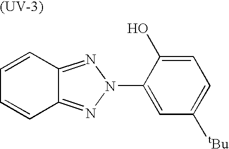

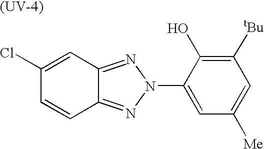

### (Preparation of Heat-Sensitive Transfer Image-Receiving Sheet 1)

A paper support, on both sides of which polyethylene was laminated, was subjected to corona discharge treatment on the surface thereof, and then a gelatin undercoat layer containing sodium dodecylbenzenesulfonate was disposed on the treated surface. The subbing layer, the heat insulation layer, the lower receptor layer and the upper receptor layer each having the following composition were simultaneously multilayer-coated on the gelatin undercoat layer, in the state that the subbing layer, the heat insulation layer, the lower receptor layer and the upper receptor layer were laminated in this order from the side of the support, by a method illustrated in FIG. 9 in U.S. Pat. No. 2,761,791. The coating was performed so that coating amounts of the subbing layer, the heat insulation layer, the lower receptor layer, and the upper receptor layer after drying would be 6.7 g/m², 8.7 g/m², 2.6 g/m² and 2.7 g/m², respectively. The following compositions are expressed by mass as a solid content.

| | |
|---|---|
| Upper receptor layer | |
| Vinyl chloride-series latex | 22.0 mass parts |
| (trade name: Vinybran 900, manufactured by Nisshin | |
| Chemicals Co., Ltd.) | |
| Vinyl chloride-series latex | 2.4 mass parts |
| (trade name: Vinybran 276, manufactured by Nisshin | |
| Chemicals Co., Ltd.) | |
| Gelatin (10% solution) | 2.0 mass parts |
| The following ester-series wax EW-1 | 2.0 mass parts |
| The following surfactant F-1 | 0.07 mass part |
| The following surfactant F-2 | 0.36 mass part |
| Lower receptor layer | |
| Vinyl chloride-series latex | 12.0 mass parts |
| (trade name: Vinybran 690, manufactured by Nisshin | |
| Chemicals Co., Ltd.) | |
| Vinyl chloride-series latex | 12.0 mass parts |
| (trade name: Vinybran 900, manufactured by Nisshin | |
| Chemicals Co., Ltd.) | |
| Gelatin (10% solution) | 10.0 mass parts |
| The following surfactant F-1 | 0.04 mass part |
| Heat insulation layer | |
| Hollow latex polymer particles | 60.0 mass parts |
| (trade name: MH5055, manufactured by Nippon Zeon | |
| Co., Ltd.) | |
| Gelatin (10% solution) | 30.0 mass parts |
| Subbing layer | |
| Polyvinyl alcohol | 6.7 mass parts |
| (trade name: POVAL PVA 205, manufactured by | |
| Kuraray) | |
| Styrene butadiene rubber latex | 60.0 mass parts |
| (trade name: SN-307, manufactured by NIPPON A & | |
| L INC) | |
| The following surfactant F-1 | 0.03 mass part |

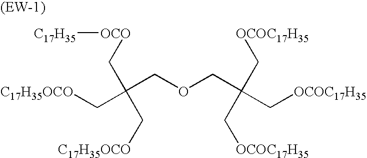

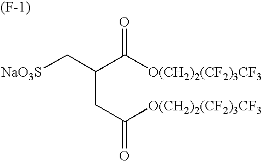

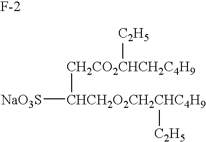

### (Preparation of Heat-Sensitive Transfer Image-Receiving Sheet 2)

A synthetic paper (trade name: Yupo FPG 200, manufactured by Yupo Corporation, thickness: 200 μm) was used as the support; and, on one surface of the support, a white intermediate layer and a receptor layer, having the following compositions, were coated in this order by a bar coater. The coating was carried out such that the amount of the white intermediate layer and the amount of the receptor layer after each layer was dried would be 1.0 g/m² and 4.0 g/m², respectively, and these layers were respectively dried at 110° C. for 30 seconds.

White intermediate layer

| | | |
|---|---|---|
| Polyester resin | 10 | parts by mass |
| (Trade name: Vylon 200, manufactured by | | |
| Toyobo Co., Ltd.) | | |
| Fluorescent whitening agent | 1 | part by mass |
| (Trade name: Uvitex OB, manufactured by | | |
| Ciba-Geigy) | | |
| Titanium oxide | 30 | parts by mass |
| Methyl ethyl ketone/toluene (1/1, at mass ratio) | 90 | parts by mass |

Receptor layer

| | | |
|---|---|---|
| Vinyl chloride/vinyl acetate resin | 100 | parts by mass |
| (Trade name: Solbin A, manufactured by | | |
| Nisshin Chemicals Co., Ltd.) | | |
| Amino-modified silicone | 5 | parts by mass |
| (Trade name: X22-3050C, manufactured by | | |
| Shin-Etsu Chemical Co., Ltd.) | | |
| Epoxy-modified silicone | 5 | parts by mass |
| (Trade name: X22-300E, manufactured by | | |
| Shin-Etsu Chemical Co., Ltd.) | | |
| Methyl ethyl ketone/toluene (1/1, at mass ratio) | 400 | parts by mass |

### (Preparation of Heat-Sensitive Transfer Image-Receiving Sheet 3)

The heat-sensitive transfer image-receiving sheet 3 was prepared in the same manner as the sample using polycarbonate C and adding plasticizer in the working example described in JP-A-62-169694.

### (Image Formation and Line Speed)

An image of 152 mm×102 mm in size was printed by using each of the above heat-sensitive transfer sheets (ink sheets) and the heat-sensitive transfer image-receiving sheet 1 in combination, while a thermal transfer printer (ASK-2000 manufactured by Fuji Photo Film Co., Ltd.) was made changeable in line speed. The line speed of the thermal transfer printer was altered to the following conditions of A to D.

TABLE 4

| | Line speed (msec/line) |
|---|---|
| Condition A | 1.40 |
| Condition B | 1.10 |
| Condition C | 0.75 |
| Condition D | 0.65 |

The image was printed in the environment at 25° C. and a relative humidity of 50%.

### (Evaluation of Image Defects)

Under the each condition as described above, cyan images at the Dmax density were continuously printed on 100 sheets. The number of the streak-like ribbon wrinkles generated during printing together with the heat-sensitive transfer sheet and the image-receiving sheet was counted and used as an indicator of image defects. The results were rated into the following five criteria.
1 (Very Good: no ribbon wrinkles were generated)
2 (Good: ribbon wrinkles were generated in one sheet)
3 (Allowable: ribbon wrinkles were generated in two or three sheets)
4 (Often unallowable: ribbon wrinkles were generated in four to nine sheets)
5 (Unallowable: ribbon wrinkles were generated in ten or more sheets)

The results obtained were shown in the column of the image defect (evaluation of ribbon wrinkling) in the following Table 5.

TABLE 5

| | | Formulation of | | | | |
|---|---|---|---|---|---|---|
| | | heat-resistant | | | | |
| | Ink | lubricating layer | Line | | | Image |
| | sheet | in ink sheet | speed | C-A | C-B | defect |
| Comparative example 1 | 1 | 2 | B | C1 | C2 | 5 |
| Comparative example 2 | 2 | 1 | B | C3 | C4 | 5 |
| Comparative example 3 | 3 | 1 | B | 2-1 | C5 | 5 |
| Comparative example 4 | 4 | 1 | B | 2-1 | C6 | 5 |
| Comparative example 5 | 5 | 1 | B | 2-1 | C7 | 5 |
| Comparative example 6 | 6 | 1 | B | 2-1 | — | 5 |
| Comparative example 7 | 7 | 1 | B | 1-5 | — | 5 |
| This invention 1 | 8 | 1 | B | 2-1 | 1-5 | 3 |
| This invention 2 | 9 | 1 | B | 2-2 | 1-1 | 3 |
| This invention 3 | 10 | 1 | B | 2-9 | 1-2 | 3 |
| This invention 4 | 11 | 1 | B | 2-20 | 1-6 | 3 |
| This invention 5 | 12 | 1 | B | 2-3 | 1-5 | 3 |
| This invention 6 | 13 | 1 | B | 2-4 | 1-1 | 3 |
| This invention 7 | 14 | 1 | B | 2-5 | 1-2 | 3 |
| This invention 8 | 15 | 1 | B | 2-6 | 1-6 | 3 |
| This invention 9 | 8 | 1 | A | 2-1 | 1-5 | 3 |
| This invention 10 | 8 | 1 | B | 2-1 | 1-5 | 3 |
| This invention 11 | 8 | 1 | C | 2-1 | 1-5 | 2 |
| This invention 12 | 8 | 1 | D | 2-1 | 1-5 | 1 |
| This invention 13 | 12 | 1 | A | 2-3 | 1-5 | 3 |
| This invention 14 | 12 | 1 | B | 2-3 | 1-5 | 3 |
| This invention 15 | 12 | 1 | C | 2-3 | 1-5 | 2 |
| This invention 16 | 12 | 1 | D | 2-3 | 1-5 | 1 |

The Comparative Example 1 corresponds to the combination of the dyes described in JP-B-5-15198, Comparative Example 2 corresponds to the combination of the dyes described in JP-A-2-74683, and Comparative Example 3 corresponds to the combination of the dyes described in JP-A-10-181222.

In addition, the image formation and the evaluation were carried out in the same manner as in the above, except that the heat-sensitive transfer image-receiving sheet 1 was replaced with the heat-sensitive transfer image-receiving sheet 2 or 3. The obtained results were similar to those when the heat-sensitive transfer image-receiving sheet 1 was used.

It is apparent from the above results that the heat-sensitive transfer sheet according to the present invention can be provide an excellent recorded image with less image defects due to wrinkling of the heat-sensitive transfer sheet (ribbon wrinkling). Further, it is understood that the transfer density, light fastness and storability over time of the heat-sensitive transfer sheet according to the present invention were also excellent.

### Example 2

An ink sheet 16 was prepared in the same manner as the ink sheet 12 in Example 1, except that polyvinyl acetal resin as a binder in the cyan dye layer was changed from KS-1 to 6000-CS (trade name, manufactured by Denki Kagaku Kogyo K.K.; ratio A of the acetoacetal group in the resin: 58 mole %). An ink sheet 17 was prepared in the same manner as the ink sheet 12 in Example 1, except that the polyvinyl acetal resin in the cyan dye layer was changed from KS-1 to 5000-D (trade name, manufactured by Denki Kagaku Kogyo K.K.; ratio A of the acetoacetal group in the resin: 66 mole %). Each of them was evaluated in the same manner as Example 1 in combination with the heat-sensitive transfer image-receiving sheet 1.

The results are summarized in Table 6.

TABLE 6

| | | Formulation of | | | | |
|---|---|---|---|---|---|---|
| | | heat-resistant | | | | |
| | | lubricating | | | | |
| | Ink | layer | Line | | | Image |
| | sheet | in ink sheet | speed | C-A | C-B | defect |
| This invention 17 | 16 | 1 | B | 2-3 | 1-5 | 3 |
| This invention 18 | 17 | 1 | B | 2-3 | 1-5 | 2 |

From the results shown in table 6, it is understood that the occurrence of image defects is further improved when the heat-sensitive transfer sheet, which has the dye layer containing the polyvinyl acetal resin having the molar ratio A of the acetoacetal groups in said resin of 60 mole % or more, is used.

What we claim is:

1. A heat-sensitive transfer sheet comprising at least one dye layer formed on one side of a base sheet, wherein the dye layer contains at least one kind of dye represented by formula (1) and at least one kind of dye represented by formula (2), 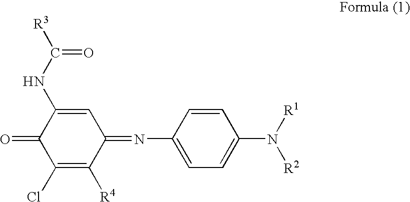
wherein, in formula (1), R¹ and R² each independently represent a substituted or unsubstituted alkyl group having 1 to 8 carbon atoms; R³ represents a substituted or unsubstituted alkyl group having 1 to 8 carbon atoms or a substituted or unsubstituted alkoxy group having 1 to 6 carbon atoms; and R⁴ represents a methyl group or an ethyl group, and 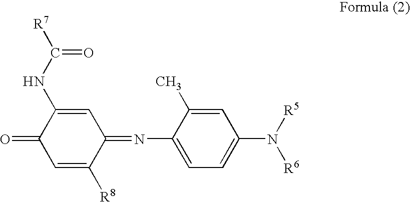
wherein, in formula (2), R⁵ and R⁶ each independently represent a substituted or unsubstituted alkyl group having 1 to 8 carbon atoms; R⁷ represents a substituted or unsubstituted alkyl group having 1 to 8 carbon atoms or a substituted or unsubstituted alkoxy group having 1 to 8 carbon atoms; and R⁸ represents a methyl group or an ethyl group.

2. The heat-sensitive transfer sheet according to claim 1, wherein, in the dye represented by formula (2), R⁵ and R⁶ each independently represent a methyl group or an ethyl group; R⁷ represents a methyl group, an ethyl group or a methoxy group; and R⁸ represents a methyl group.

3. A heat-sensitive transfer recording method comprising forming an image on a heat-sensitive transfer image-receiving sheet which has an ink receiving layer containing a polymer on a support, by using the heat-sensitive transfer sheet according to claim 1.

4. The heat-sensitive transfer recording method according to claim 3, wherein the image is formed with the line speed of from 0.50 msec/line to 0.73 msec/line.
